(19) United States
(12) Patent Application Publication
(10) Pub. No.: US 2004/0160764 A1
(43) Pub. Date: Aug. 19, 2004

(54) Melody candle assembly using color change pigment

(76) Inventor: Jea-Chul Lee, Busan (KR)

Correspondence Address: ST. ONGE STEWARD JOHNSTON & REENS, LLC, 986 BEDFORD STREET, STAMFORD, CT, 06905-5619, US

(21) Appl. No.: 10/782,223

(22) Filed: Feb. 19, 2004

(30) Foreign Application Priority Data
Feb. 19, 2003 (KR) 2003-4823

(51) Int. Cl. F21L 19/00

(52) U.S. Cl. 362/161

(57) ABSTRACT

Disclosed is a melody candle assembly that can reproduce a piece of melody or music by use of an optical fiber when a wick is ignited, and more particularly, to a melody candle assembly using a color change pigment for reproducing a piece of melody or music responding to a light signal, wherein the color change pigment is coated on the optical fiber in the candle, the color change pigment being in black-like colors at normal states and getting changed to transparent colors at a time of the application of heat when the candle is burnt, and when the wick is ignited, the light of the candle is transmitted to the optical fiber and a photo sensor through the color change pigment transparent in color due to heat from flame of the candle, thus to operate a melody reproducing unit, and when the candle is put out, the color change pigment is changed to the black-like colors again to shield the exposed end portion of the optical fiber from the outside light such as sunlight or lamp light, thereby preventing the melody reproducing unit from being erroneously operated by the outside light.

This application claims priority of pending Korean Patent Application No. 2003-0004823 filed on Feb. 19, 2003.

### FIELD OF THE INVENTION

The present invention relates to a melody candle assembly that can reproduce a piece of melody or music by use of an optical fiber when a wick is ignited, and more particularly, to a melody candle assembly using a color change pigment for reproducing a piece of melody or music responding to a light signal, wherein the color change pigment is coated on the optical fiber in the candle, the color change pigment being in black-like colors at normal states and getting changed to transparent colors at a time of the application of heat when the candle is burnt, and when the wick is ignited, the light of the candle is transmitted to the optical fiber and a photo sensor through the color change pigment transparent in color due to heat from flame of the candle, thus to operate a melody reproducing unit, and when the candle is put out, the color change pigment is changed to the black-like colors again to shield the exposed end portion of the optical fiber from the outside light such as sunlight or lamp light, thereby preventing the melody reproducing unit from being erroneously operated by the outside light.

### BACKGROUND OF THE RELATED ART

Candles, which reproduce a melody or a simple sound like a message when a wick is ignited, are widely used for presents or decoration. Generally, the melody candle assembly is provided with light sensing means that senses flame produced when the wick is ignited and a melody reproducing unit that reproduces a melody or sound when the flame is sensed the light sensing means. In most cases, the light sensing means includes an optical fiber and a photo sensor.

In the structure of the light sensing means employing the optical fiber and the photo sensor, conventionally, cotton threads are wound around the outer peripheral surface of the optical fiber. In this manner, however, the cotton threads that are wound around the optical fiber fails to completely shield the sunlight or lamp light such that the melody reproducing unit is erroneously operated. Furthermore, the wick is bent to cover the optical fiber such that the photo sensor is erroneously operated.

### SUMMARY OF THE INVENTION

Accordingly, the present invention has been made in view of the above problems occurring in the prior art, and it is an object of the present invention is to provide a melody candle assembly using a color change pigment for reproducing a piece of melody or music responding to a light signal, wherein the color change pigment is coated on the optical fiber in the candle, the color change pigment being in black-like colors at normal states and getting changed to transparent colors at a time of the application of heat when the candle is burnt, and when the wick is ignited, the light of the candle is transmitted to the optical fiber and a photo sensor through the color change pigment transparent in color due to heat from flame of the candle, thus to operate a melody reproducing unit, and when the candle is put out, the color change pigment is changed to the black-like colors again to shield the exposed end portion of the optical fiber from the outside light such as sunlight or lamp light, thereby preventing the melody reproducing unit from being erroneously operated by the outside light.

To achieve the above object, according to the present invention, there is provided a melody candle assembly using a color change pigment a candle having a wick and an optical fiber embedded in the center thereof in parallel with each other, the wick being of a substantially thin thread or fabric made of a natural fiber or a chemical fiber, the optical fiber being adapted to transmit light from flame produced when the wick is ignited, wherein the optical fiber is coated with the color change pigment that stays in black-like colors to shield light at normal states and gets changed to transparent colors at a time of the application of heat when the candle is burnt; a photo sensor disposed at the lower end of the optical fiber while being in contact with the lower end of the optical fiber, for sensing the light transmitted through the optical fiber; and a melody reproducing unit mounted at the lower end portion of the candle for reproducing the melody or music when the photo sensor senses the light from the optical fiber, the melody reproducing unit having an electronic circuit module, a battery container into which batteries are mounted and a speaker for outputting the melody or music generated from the electronic circuit module to the outside.

### BRIEF DESCRIPTION OF DRAWINGS

The above and other objects, features and advantages of the present invention will be apparent from the following detailed description of the preferred embodiments of the invention in conjunction with the accompanying drawings, in which:

FIG. 1 is a longitudinal sectional view of a melody candle assembly using a color change pigment according to the present invention;

FIGS. 2a and 2b are views showing the changing states of the color change pigment in the melody candle assembly of this invention; and

FIG. 3 is an operational concept view showing the melody candle assembly of this invention.

### DETAILED DESCRIPTION OF PREFERRED EMBODIMENT

Reference will now be made in detail to the preferred embodiments of the present invention, examples of which are illustrated in the accompanying drawings.

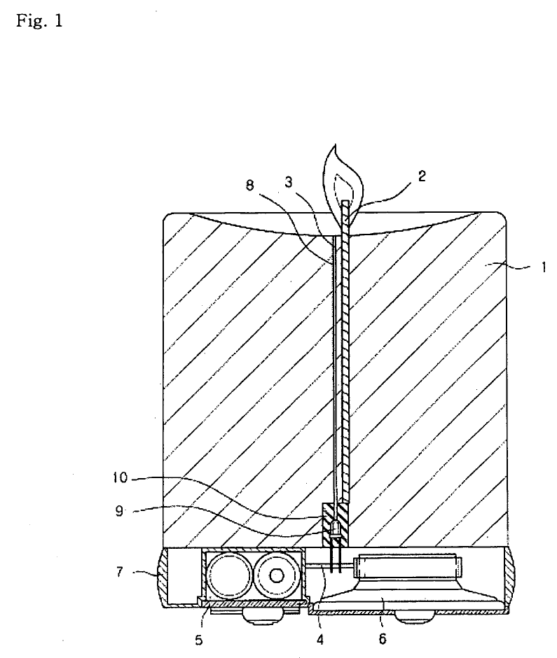

FIG. 1 is a longitudinal sectional view of a melody candle assembly using a color change pigment according to the present invention. Referring to FIG. 1, there is shown a melody candle assembly using a color change pigment for reproducing a piece of melody or music responding to a light signal, comprising: a candle 1 having a wick 2 and an optical fiber 3 embedded in the center thereof in parallel with each other, the wick 2 being of a substantially thin thread or fabric made of a natural fiber or a chemical fiber, the optical fiber 3 being adapted to transmit light from flame produced when the wick 2 is ignited, wherein the optical fiber 3 is coated with the color change pigment 8 that stays in black-like colors at normal states and gets changed to transparent colors at a time of the application of heat when the candle 1 is burnt; a photo sensor 9 disposed at the lower end of the optical fiber 3 while being in contact with the lower end of the optical fiber 3, for sensing the light transmitted through the optical fiber; and a melody reproducing unit 7 mounted at the lower end portion of the candle for reproducing the melody or music when the photo sensor senses the light from the optical fiber, the melody reproducing unit 7 provided with an electronic circuit module 4, a battery container 5 into which batteries are mounted and a speaker 6 for outputting the melody or music generated to the outside.

According to the present invention, a metal coated sensor socket 10 is mounted around the photo sensor 9 for preventing the photo sensor from being erroneously operated in response to the outside light coming from the outer peripheral surface of the candle 1.

Now, an explanation of the operational effect of the melody candle assembly of this invention will be given.

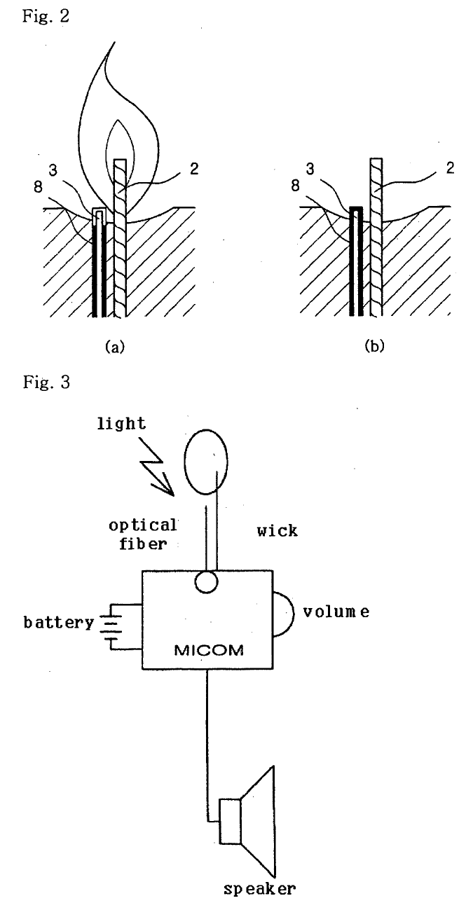

When the wick 2 is ignited, flame is produced at the top end portion of the wick 2, and thus, the color change pigment 8 that is coated around the optical fiber 3 adjacent to the wick 2 gets transparent by heat from the flame, as shown in FIG. 2a. The light from the flame of the candle 1 is transmitted to the other end of the optical fiber 3 connected to the photo sensor 9 through the optical fiber 3 coated with the color change pigment 8. If the photo sensor 9 is operated in response to the light transmitted through the optical fiber 3, the power is applied from the batteries in the melody reproducing unit 7 to the electronic circuit module 4 which in turn operates to reproduce the melody via the speaker 6. As shown in FIG. 3, such an operation is carried out in the aforementioned fashion.

If the candle 1 is put out, on the other hand, the temperature at the top end of the candle 1 becomes low and the color change pigment 8 that is coated around the optical fiber 3 adjacent to the wick 2 gets dark like black, as shown in FIG. 2b. Thereby, the outside light such as sunlight or lamp light is not transmitted to the optical fiber 3, which can prevent the photo sensor 9 from being erroneously operated by the outside light.

In addition, a metal coated sensor socket 10 is mounted around the photo sensor 9 including a portion thereof joined with the optical fiber 3, for preventing the photo sensor 9 from being erroneously operated in response to the outside light coming from the outer peripheral surface of the candle 1.

As clearly described above, a melody candle assembly using a color change pigment according to the present invention can reproduce a melody when the candle is lighted and stop reproducing of the melody when the candle is put out, and the application of the color change pigment prevents the melody reproducing unit from erroneously operated by the outside light such as the sunlight or lamp light.

In addition, the melody candle assembly of this invention can prevent batteries in the melody reproducing unit from being unnecessarily consumed by having no operation of the melody reproducing unit after the candle is put out.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A melody candle assembly using a color change pigment, comprising:
a candle having a wick and an optical fiber embedded in the center thereof in parallel with each other, the wick being of a substantially thin thread or fabric made of a natural fiber or a chemical fiber, the optical fiber being adapted to transmit light from flame produced when the wick is ignited, wherein the optical fiber is coated with the color change pigment that stays in black-like colors to shield light at normal states and gets changed to transparent colors at a time of the application of heat when the candle is burnt;
a photo sensor disposed at the lower end of the optical fiber while being in contact with the lower end of the optical fiber, for sensing the light transmitted through the optical fiber; and
a melody reproducing unit mounted at the lower end portion of the candle for reproducing the melody or music when the photo sensor senses the light from the optical fiber, the melody reproducing unit having an electronic circuit module, a battery container into which batteries are mounted and a speaker for outputting the melody or music generated to the outside.

2. The melody candle assembly according to claim 1, wherein a metal coated sensor socket is mounted around the photo sensor including a portion thereof joined with the optical fiber, for preventing the photo sensor from being erroneously operated in response to the outside light coming from the outer peripheral surface of the candle.
